(19) United States
(12) Patent Application Publication
(10) Pub. No.: US 2025/0361932 A1
(43) Pub. Date: Nov. 27, 2025

(54) DRIVE ASSEMBLY WITH AIR VENTS

(71) Applicant: Magna PT B.V. & Co. KG, Untergruppenbach (DE)

(72) Inventor: Holger KUFELD, Murr (DE)

(21) Appl. No.: 19/195,773

(22) Filed: May 1, 2025

(30) Foreign Application Priority Data
May 23, 2024 (DE) 102024204744.9

(51) Int. Cl. F16H 57/027; F16H 57/04

(52) U.S. Cl. CPC F16H 57/027; F16H 57/045; F16H 57/0483

(57) ABSTRACT

A drive assembly including a contiguous oil chamber having at least two vents, wherein—depending on the inclined state of the drive assembly—one of the vents always lies above the current oil level in the oil chamber.

### Cross-Reference to related applications

This application claims priority to German Application No. DE 102024204744.9 filed on May 23, 2024. The entire disclosure of the above application is incorporated herein by reference.

### FIELD OF THE INVENTION

The invention relates to a drive assembly including a contiguous oil chamber having at least two vents.

### BACKGROUND OF THE INVENTION

This section provides information related to the present disclosure which is not necessarily prior art.

A comparatively high input of air into the oil required for lubricating transmission parts is to be noted in particular, in transmissions which are operated at high rotating speeds, an oil foam thus being formed. This state is highly undesirable because this oil/air mixture does not guarantee an adequate lubrication of the transmission parts. Therefore, venting systems are used in order to separate the air from the oil foam, and to then supply the separated oil to the transmission parts to be lubricated.

Such a venting system for oil in a transmission is known from DE 10 2017 114 889 A1. Here, a pacification chamber is provided with various webs so that the oil foam is guided in a forced flow through the pacification chamber.

Known from DE 10 2021 207 712 A1 is a drive assembly having a contiguous oil chamber having at least two vents. The vents are disposed in the oil chamber in such a manner that—depending on the inclined state of the drive assembly—one of the vents lies above the current oil level in the oil chamber.

Depending on the driving or operating situation, or else also as a consequence of the concept, e.g. separate oil tank, spaces which contain a high oil level are formed in the system. If the assembly is designed in such a way for reasons relating to space or function that a vent is installed exactly there, this may lead to a leakage of oil.

### SUMMARY OF THE INVENTION

This section provides a general summary of the disclosure and is not a comprehensive disclosure of its full scope or all of its features.

The object of the venting system disclosed herein is not the separation of air from the oil/air mixture, but the equalization of pressure in the transmission and in the transmission system. In the process, neither oil nor surface foam, thus the oil/air mixture, above the oil level must leak out.

Additionally, the vent must not allow the ingress or water or dirt, this often representing an issue due to requirements of vehicle manufacturers relating to the wading capability of the vehicle.

It is another object of the invention to achieve a drive component which prevents the leakage of oil from the vent without complexity.

These object are achieved by a drive assembly including a contiguous oil chamber having at least two vents, wherein—depending on the inclined state of the drive assembly—one of the vents always lies above the current oil level in the oil chamber.

A drive assembly is understood to mean transmissions, transmission parts, transfer cases, electric machines, differentials, etc.

In terms of the structural complexity, the use of two vents is optimal; however, it is also possible to install more than these two vents.

In an advantageous embodiment, attached to each vent is in each case one hose piece, the latter connecting to one another so as to form a venting hose, this being important in the case of the requirement of a higher wading level.

The hose is flexible in terms of its length at least in parts.

The first vent is installed at the highest position of the drive assembly in the normal position of the latter.

The normal position is understood to mean a horizontal footing of a vehicle, and the thus defined installed position of the drive assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a drive assembly in a horizontal driving position; and

FIG. 2 shows the drive assembly in an oblique position.

### DESCRIPTION OF THE INVENTION

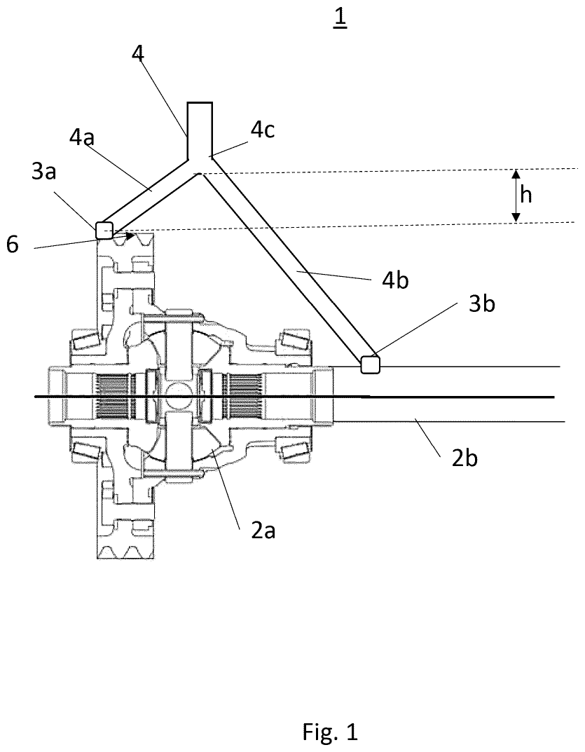

Chosen as a non-limiting example of a drive assembly 1 is a differential 2a which by way of example is provided with a side output shaft 2b. In FIG. 1, the differential 2a is shown in a horizontal installed situation and driving situation. During operation, the differential is covered by a layer of oil which is flung outwards by the rotatable components. Only a small amount of oil is present above the shaft on the side output shaft 2b, because the shaft is of a smooth design and cannot entrain much oil. A common oil chamber is present here. In this way, there is a high oil level at a first vent 3a, while there is a very low oil level at a second vent 3b.

A pressure equalization takes place at the point of the lowest oil level, using the second vent 3b.

Hose pieces, i.e. a first hose piece 4a and a second hose piece 4b, are in each case attached to the first vent 3a and to the second vent 3b. The two hose pieces meet at a connection point 4c, so as to form a venting hose 4. The connection point 4c lies at a height h above the first vent 3a, the highest internal oil level 6.

By way of the height h there exists a sufficient spacing to prevent the oil leaking into the first hose piece 4a from filling the entire venting region. Venting takes place by way of the second hose piece 4b into the venting hose 4.

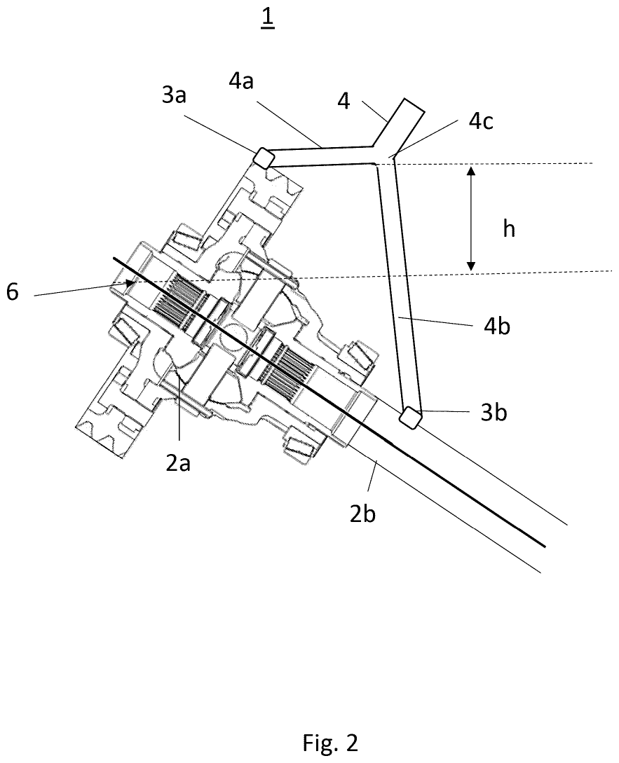

Illustrated in FIG. 2 is the differential 2a having the axle side shaft 2b in an inclined position in comparison to the horizontal. As a result of the inclined position, oil from the upper region of the drive assembly 1 runs into the axle side shaft 2b. In this way, the first vent 3a is lifted significantly above the oil level. In turn, the second vent 3b is located below the oil level. In this way, venting of the drive assembly 1 takes place by way of the first vent 3a, wherein the spacing h between the oil level and the connection point 4c of the venting hose 4 is larger than during horizontal operation. The venting hose 4, with its two hose parts 4a and 4b, is made of a flexible material.

The venting does not require any check valves.

An alternative embodiment can dispense with the hose parts 4a and 4b and the venting hose 4.

Such an embodiment can be used when the oil level does not reach the first vent 3a in any driving condition. In this instance, the spacing h would not be defined by the spacing of the connection point 4a of the venting hose 4 from the oil level, but by the spacing of the first vent 3a from the oil level 6. Oil level in this context also means the level of the oil foam.

In such an embodiment, the position of the second vent 3b relative to the first vent 3a is more critical than in the embodiment having the venting hose 4; the second vent is installed in a position which under certain driving conditions is best suitable for establishing a pressure equalization, the oil efficiently receding from the installation point during a braking procedure, for example.

1. A drive assembly including a contiguous oil chamber having at least two vents, wherein—depending on the inclined state of the drive assembly—one of the vents lies above the current oil level in the oil chamber, and wherein the first vent is installed at the position of the drive assembly in the normal position of the latter which under specific driving conditions becomes free of oil.

2. The drive assembly according to claim 1, wherein attached to each vent is in each case one hose piece, the latter connecting to one another so as to form a venting hose.

3. The drive assembly according to claim 2, wherein the venting hose is flexible in terms of its length at least in parts.

4. The drive assembly according to claim 1, wherein the first vent is installed at the highest position of the drive assembly in the normal position of the latter.
